(19) United States
(12) Patent Application Publication
(10) Pub. No.: US 2010/0100408 A1
(43) Pub. Date: Apr. 22, 2010

(54) Professional continuing competency optimizer

(76) Inventor: Kenneth W. Dion, Austin, TX (US)

Correspondence Address: Michael T. Perkins, 902 McPhaul st, Austin, TX, 78758, US

(21) Appl. No.: 12/255,143

(22) Filed: Oct. 21, 2008

(51) Int. Cl. G06Q 10/00; G06F 11/34; G06F 9/00; G06Q 90/00

(52) U.S. Cl. 705/8; 705/11; 705/320; 705/328

(57) ABSTRACT

A system, method, and computer product for implementing a multifaceted professional continuing competency management software product that addresses the evolved employment environment challenges. This comprehensive computer technology solution includes knowledge management, skill evaluation, individual portfolios, staffing methods, and performance management to enable implementation of a professional continuing competency optimizer for professional organization(s) and to the individual professional.

### FEDERALLY SPONSORED RESEARCH

No

### SEQUENCE LISTING OR PROGRAM

No

### RELATED APPLICATIONS

“System and method for organizational and personal portfolios” by Kenneth W. Dion application Ser. No. 11/542,839, dtd. Oct. 4, 2006, “System and method for implementing critical checklists” by Kenneth W. Dion application Ser. No. 11/712,114, dtd. Feb. 28, 2007, “Method and system for educational compliance and competency management” by Kenneth W. Dion application Ser. No. 11/821,405, dtd. Jun. 22, 2007, “System and method for dynamic staff bidding” by Kenneth W. Dion application Ser. No. 11/888,159, dtd. Jul. 31, 2007. “System, method, and computer product for implementing a 360 degree critical evaluator” by Kenneth W. Dion, application Ser. No. 12/214,185, dtd. Jun. 16, 2008.

### BACKGROUND

1. Technical Field of Invention 705/08

This invention relates to data processing and more particularly to such a processing analysis with allocating resources or scheduling for an administrative function enabling implementation professional continuing competency optimization.

2. Background of the Invention

At the beginning of the 21 St century career employment for individual professionals is evolving from the classical model of learning a trade; practicing the trade and passing the trade on to offspring. Through attaining professional status by university training and certification through such as bar exams. Resumes have been a popular reflection of individual professional career. Many companies and certifying professional organizations are now requiring continuing education and periodic testing to assure an individual's professional competency. Resumes are presently considered two dimensional (and missing a 3^{rd} dimension; the individual) and are mostly inadequate for the present professional job scene. The employment of professionals by organizations is also evolving from long term stability for professional employees to one of resources (capabilities of the professional) as needed where needed. Previously a small percentage of employees consulted or “floated” to meet the temporary and specialty needs of organizations. Presently in many industries where resources are in short supply most individuals are moved around to satisfy such needs. Resources become virtual (available over internet connections) but how to know what is needed about the capabilities of a specific resource for comfort in engaging this “strange” resource; information beyond a resume.

What is needed is a multifaceted professional competency management software product that addresses these new challenges. This comprehensive computer technology solution must include knowledge management, skill evaluation, individual portfolios, staffing method, and performance management not only to the organization but also to the individual professional.

### SUMMARY OF THE INVENTION

A system, method, and computer product for implementing a multifaceted professional competency management software product that addresses the evolved employment environment challenges. This comprehensive computer technology solution addresses these multifaceted competency management requirements through a collection of program modules with inter-accessible information and data including knowledge management, skill evaluation, individual portfolios, staffing methods, and performance management to enable implementation of a professional continuing competency optimizer for organization(s) and to the individual professional. Through a full cycle or 360 degree process where individuals and supervisors work together to optimize professional experiences and growth plans; an optimization of competency continuance is implemented. The system consists of a subscriber based internet connected user to a provider facilitating 24/7 access to knowledge management, skill evaluation, individual portfolios, staffing methods, and performance management applications through a secure and easy to use collection of computer interface screens. The system, method, and computer product will enhance an organization's overall efficiency implementing the best practices competency management for an organization and performance management with improved information accuracy and reduced support time requirements to assure a talented reliable staffing solution that improves with experience.

### BRIEF DESCRIPTION OF THE DRAWINGS

FIG. 1 shows a functional block diagram of a professional continuing competency optimizer.

FIG. 2 shows a program flow of a professional continuing competency optimizer.

FIG. 3 shows a command page of a professional continuing competency optimizer.

FIG. 4 shows a compliance tools page of a professional continuing competency optimizer.

FIG. 5 shows a manager tools page of a professional continuing competency optimizer.

FIG. 6 shows a personal tools page of a professional continuing competency optimizer.

FIG. 7 shows a document library page of a professional continuing competency optimizer.

FIG. 8 shows a reporting and analysis page of a professional continuing competency optimizer.

FIG. 9 shows a manage openings page of a professional continuing competency optimizer.

FIG. 10 shows a manage competencies page of a professional continuing competency optimizer.

FIG. 11 shows a manage documents and images page of a professional continuing competency optimizer.

FIG. 12 shows a manage evaluations page of a professional continuing competency optimizer.

FIG. 13 shows a manage local settings page of a professional continuing competency optimizer.

### DETAILED DESCRIPTION OF THE DRAWINGS

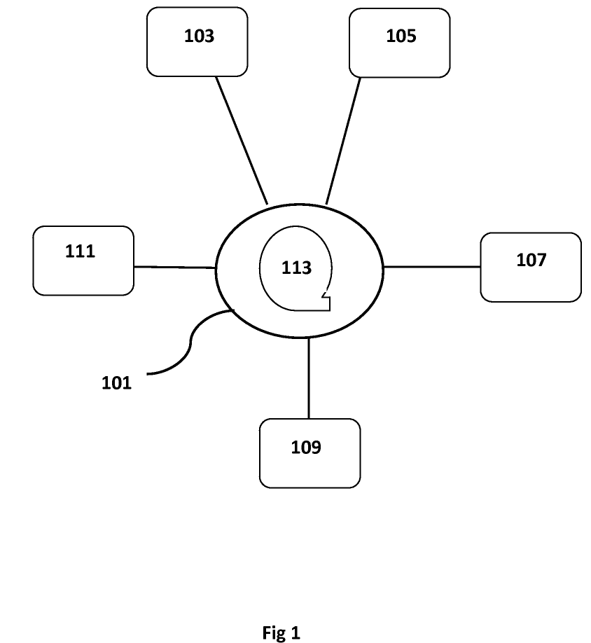

FIG. 1 shows a functional block diagram of a professional continuing competency optimizer. A computer architecture that is a collection of functions represented by connected blocks that perform the individual tasks that interface to the continuing competency optimizer 101 support system. Through an inter-accessible collection of streamlined and compatible software modules, a compatible data word format, and a common data storage 113 repository (shared database) a synergistic system is implemented. A standard definition of synergy follows; Synergy (from the Greek synergo, συνεργóξ; meaning working together) is the term used to describe a situation where the final outcome of a system is greater than the sum of its parts. In this invention the synergy results from the crafting of the software modules that interface through a standard metaphor and optimally and securely share common data to minimize the time, updates, attention, and energy necessary for a manager to grow and sustain a staff in a dynamic environment. The functions that implement competency optimization follow. A block staffer 103 represents position management allows flexible shift position scheduling and employee autonomy. The staffer 103 is based on the idea that specific assignments require particular qualifications. The staffer 103 facilitates on-line shift bidding with prequalified bidders reducing duplication of effort by the management in need of qualifications. A block portfolio 105 is an advanced generation of resumes or curriculum vitae. The portfolio 105 is the consummate representation of professional abilities, achievements, and efforts acts as a secure repository and safety-deposit box for an individual's documentation that is available anytime, anywhere (with the established password). A block evaluator 107 is an improved effective way to evaluate professional's competencies. The evaluator 107 allows organizations to focus on quality improvement by concentrating on enhancing individual performance and competence, not the processes. A block educator 109 is a total solution for an organization's required and/or continuing education delivery and tracking needs. The educator 109 is designed to provide educators with the tools to dramatically lower educational expenses, master the challenges of staff education and tracking, and perform complex data mining and compliance reporting. A block checklists 111 enable organizations to automate the management and monitoring of staff competencies. The block checklists 111 facilitate the most current method of accessing and maintaining specific skills required for organization success and risk mitigation. A collection of checklists are now available to assess an individual's competencies at a task prior to performing a task.

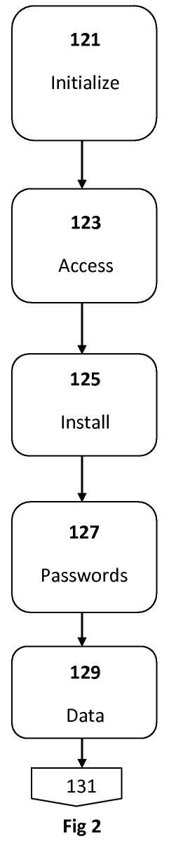

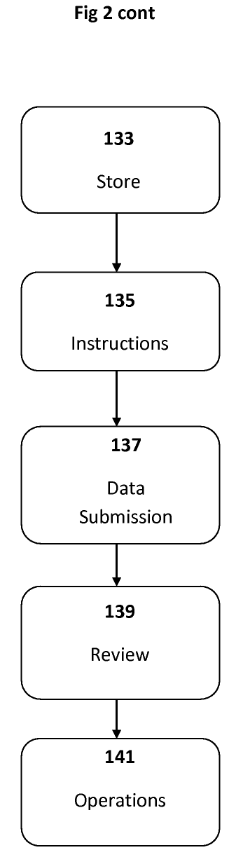

FIG. 2 shows a program flow of a professional continuing competency optimizer. An organization utilizing a professional continuing competency optimizer will typically start by establishing a secure account in block initialize 121 with a provider to operate on the contracting organization's computers and network communicating over the internet or similar configuration to the provider. A block access 123 is the next step wherein the contracting organization access the forms, software, and interfaces from the provider. A block install 125 is the next step for the contracting organization to load, install, and make operational the programs with the contracting organization's present information technology operations. A block passwords 127 is the next step wherein the contracting organization establishes the user names and obtains the passwords from the provider. A contracting organization may have specific customization requirements; typically users are grouped for types of access and privileges. There are six types of users allowed in the system. Each user type has varying levels of system access. A typical access schema follows (as determined during setup process).
Provider
Instructor
User
Manager/Supervisor
Organization Administrator
System Administrator

A block data 129 is the next step wherein a contracting organization will transfer, upload, and enter data for individuals by the contracting organization's optimal method. The standard data word format of the professional continuing competency optimizer allows ease of transfer of existing data and simple computer interface entry screens assist individuals in entry of new data. A connector 131 indicates the flow is continued on the next page. A block store 133 follows when data are entered by the contracting organization transmitted over the internet to and stored by the provider. A block instructions 135 wherein the provider and contracting organization familiarizes individuals on system usage within the organization's operations. A block data submission 137 follows wherein contracting organizations individuals, supervisors, and other staff complete operational and daily updates as part of the organization's operations and the provider stores updates and changes. A block review 139 follows and facilitates managerial review of any sensitive changes to data entries as desired by the contracting organization. A block operations 141 indicates the professional continuing competency optimizer is typically ready for day to day operations facilitating the personal management and educational tasks with review and feedback is available through a single interface to minimize time and energy expended by the contracting organization's staff.

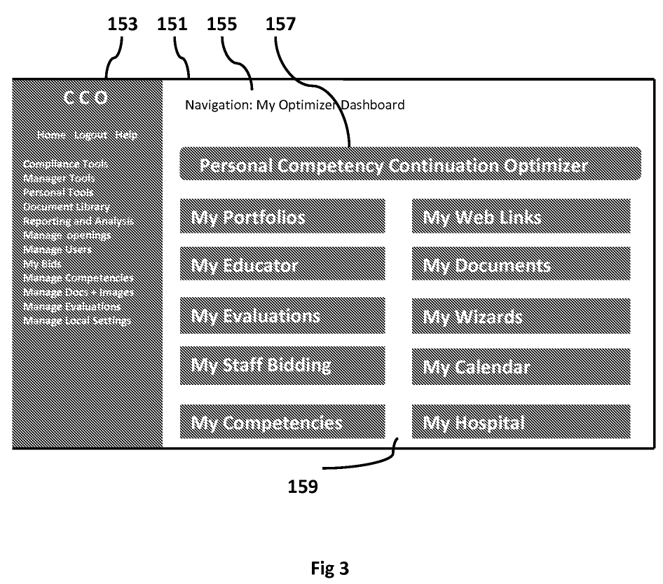

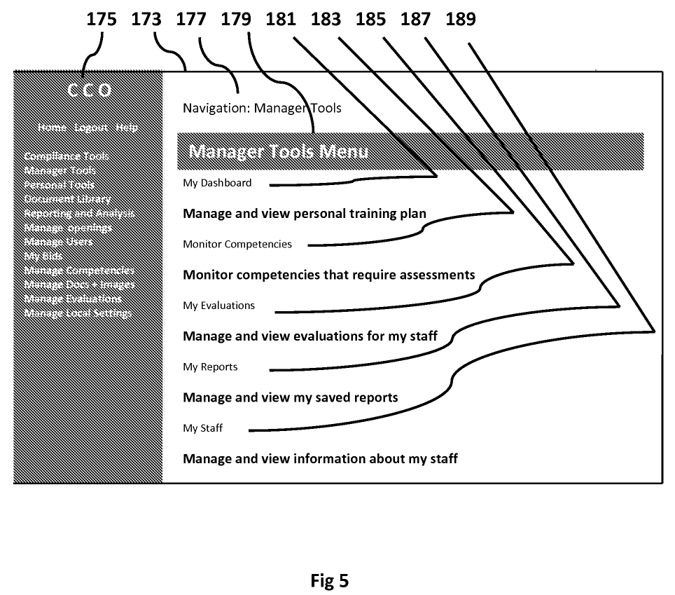

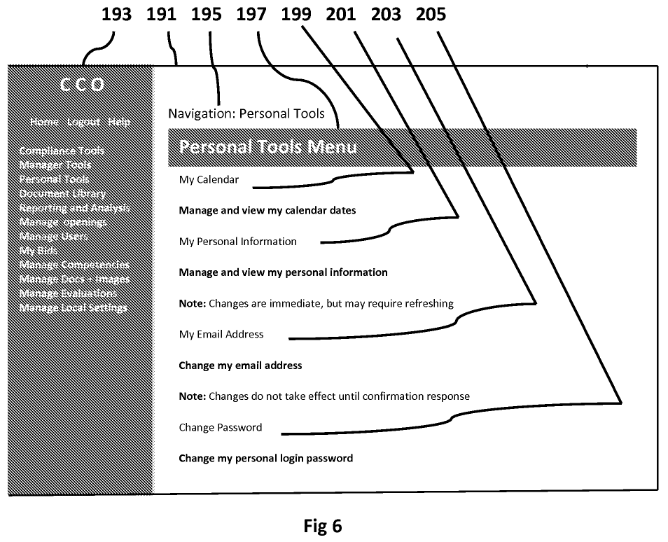

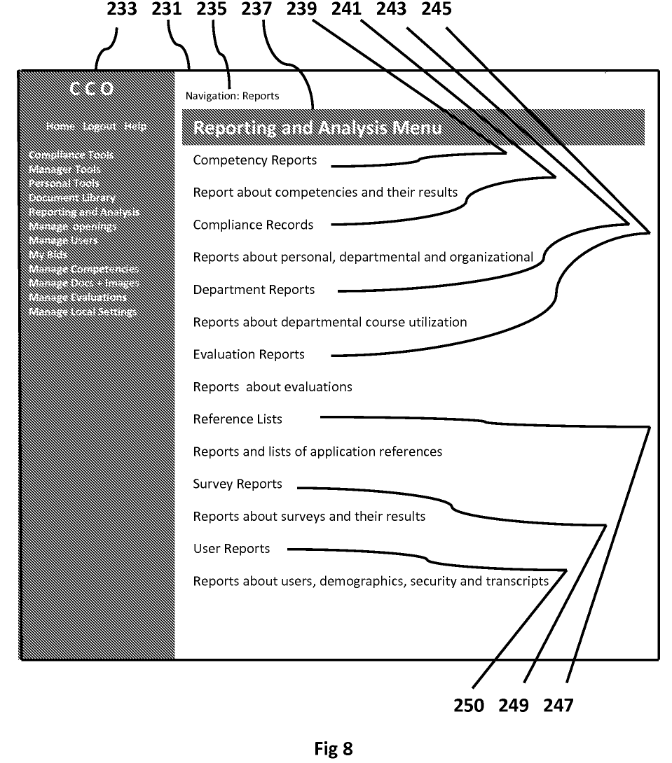

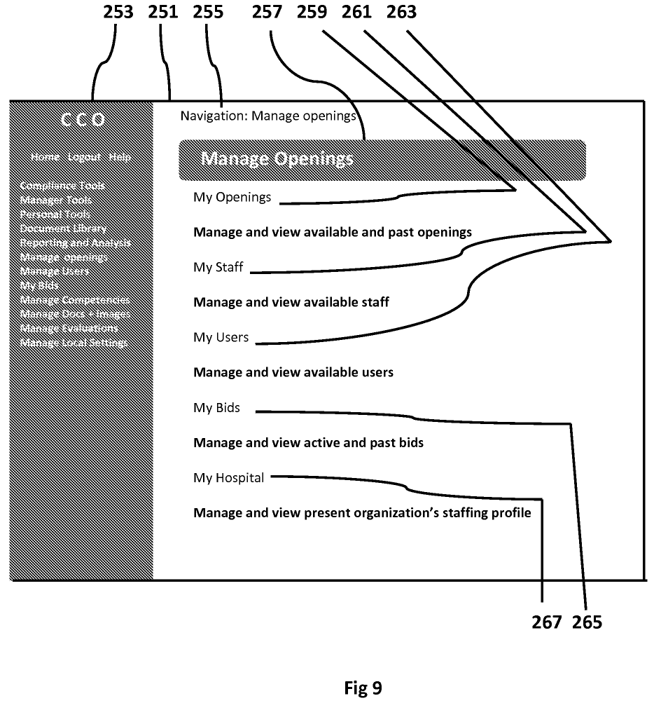

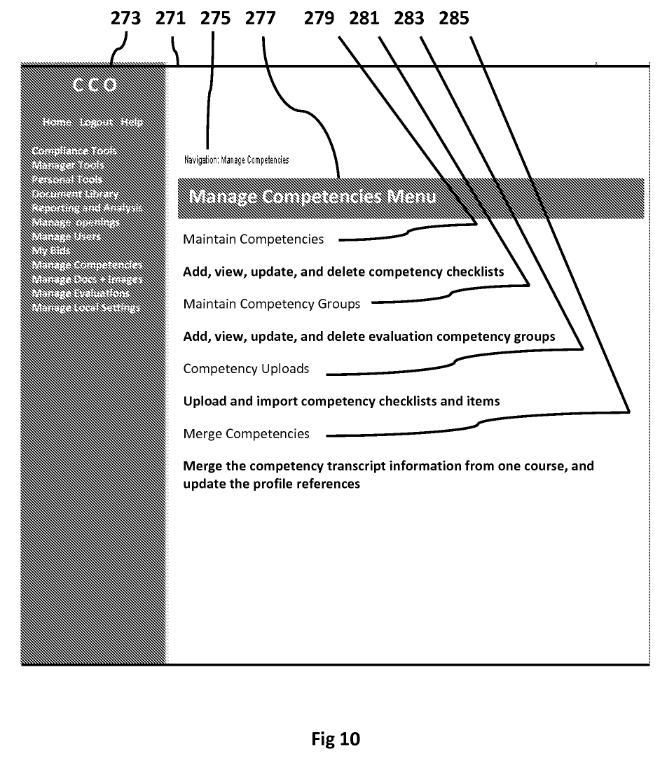

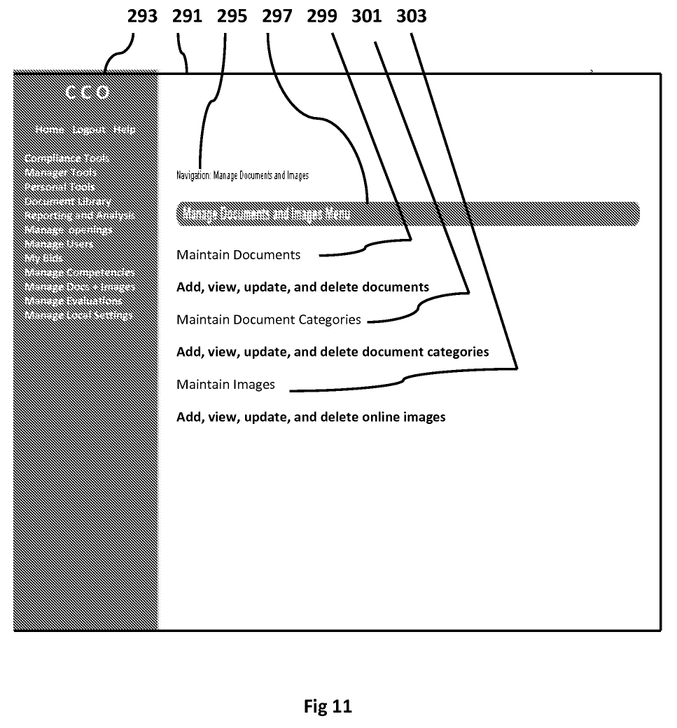

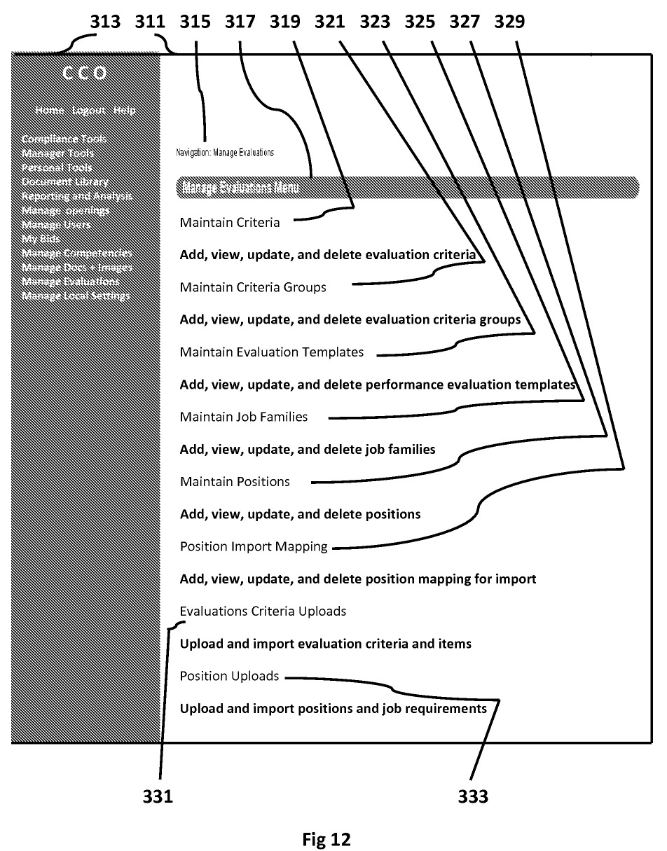

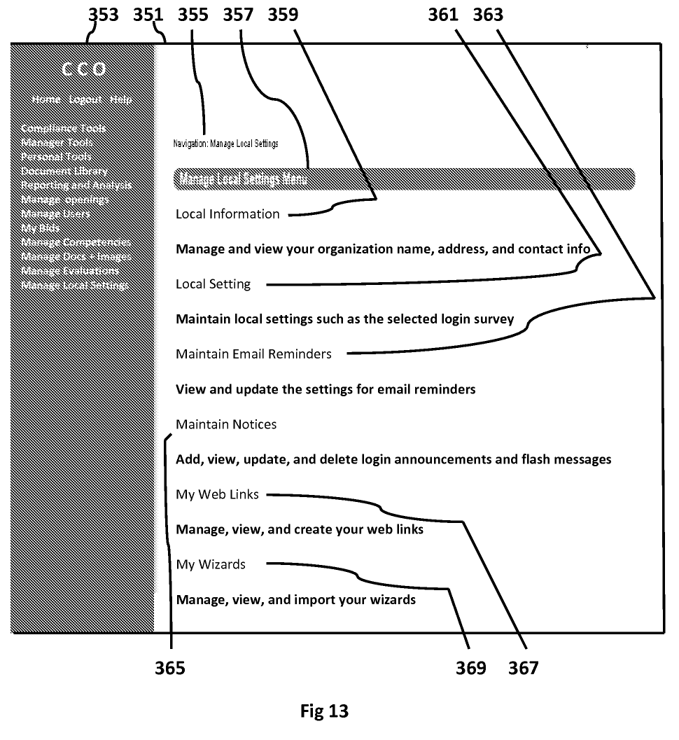

FIG. 3 shows a command page of a professional continuing competency optimizer. A command page computer interface screen 151 is shown. The screen 151 facilitates an individual's optimizer home page. A right portion 153 of screen 151 features a simple list of immediately available destinations (each line below the title is a hot spot for navigation to the respective interface screen). The lines displayed in portion 153 are title block (not a hot spot): CCO (Continuing Competency Optimizer), Home (interface screen presently displayed), Logout (for exiting the system) and Help (assistance in navigation and entry of data), Compliance tools: typically consisting of individual training plans and transcripts, Manager tools: typically consisting of a dashboard with personal training plans, monitor competencies, evaluations, reports, and staff, Personal tools: typically consisting of personal information, email addresses, changing password, Document library: typically consisting of individual, local, organizational, and professional reference library documents, Reporting and analysis: typically consisting of competency reports, compliance records, department records, evaluation reports, reference lists, survey reports, and user reports, Manage openings: typically consisting of openings, users, bids, staff, calendar, and hospital, Manage competencies: typically consisting of maintain competencies, competency groups, competency uploads, and merge competencies, Manage documents and images: typically consisting of maintain documents, maintain document categories, and maintain images, Manage evaluations: typically consisting of maintain criteria, maintain criteria groups, maintain evaluation templates, maintain job families, maintain positions, position import map, evaluation criteria uploads, and position uploads, Manage local settings: typically consisting of local information, local settings, maintain email reminders, and maintain notices. A navigation bar 155 is shown with present destination “My Optimizer”, home screen. A center screen title bar 157 displays “Personal Competency Continuation Optimizer”. A collection of title boxes, that are additionally hot spot navigation enabled, are shown in an area 159 below bar 157. The title boxes displayed in area 159 represent a series of inter-accessible data programs. These programs feature modular available information for reuse in all the following programs. The title boxes shown in area 159 are: My Portfolios: individuals portfolios are contained in Monitor Competencies in the manager tools interface screen and group portfolios are contained in My Staff also on the manager tools interface screen, FIG. 5, My Educator: are contained in competency and compliance records on reporting and analysis interface screen, FIG. 8, My Evaluations: are contained in Manage Evaluations interface screen, FIG. 12, My Staff Bidding: is contained in Manage Openings interface screen, FIG. 9, My Competencies: are contained in Manage Competency interface screen, FIG. 10, My Web Links: are contained in Manage Local Settings interface screen, FIG. 13, My Documents: are contained in Manage Documents and Images interface screen, FIG. 11, My Wizards: are contained in Manage Local Settings interface screen, FIG. 13, My Calendar: is contained in Personal Tools interface screen, FIG. 6, My Hospital: is contained in Manage Openings interface screen, FIG. 9. The organization “Hospital” is used as an example and any organization can utilize the functionality of the present invention with minor customization during the set up by the provider discussed in FIG. 2.

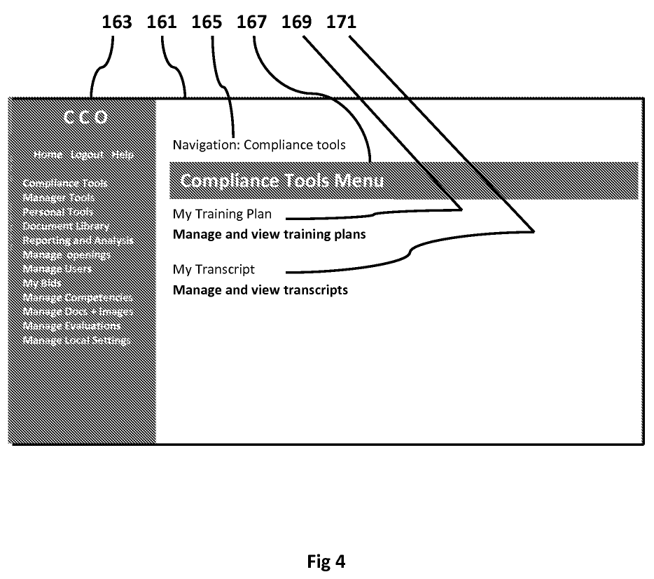

FIG. 4 shows a compliance tools page of a professional continuing competency optimizer. A typical compliance tools interface screen 161 is shown. A right portion 163 of screen 161 features a simple list of immediately available destinations (each line is a hot spot for navigation to the respective interface screen). The lines displayed in portion 163 are title block (not a hot spot): CCO, Home (interface screen presently displayed), Logout (for exiting the system) and Help (assistance in navigation and entry of data), Compliance tools: typically consisting of individual training plans and transcripts, Manager tools: typically consisting of a dashboard with personal training plans, monitor competencies, evaluations, reports, and staff, Personal tools: typically consisting of personal information, email addresses, changing password, Document library: typically consisting of individual, local, organizational, and professional reference library documents, Reporting and analysis: typically consisting of competency reports, compliance records, department records, evaluation reports, reference lists, survey reports, and user reports, Manage openings: typically consisting of openings, users, bids, staff, calendar, and hospital, Manage competencies: typically consisting of maintain competencies, competency groups, competency uploads, and merge competencies, Manage documents and images: typically consisting of maintain documents, maintain document categories, and maintain images, Manage evaluations: typically consisting of maintain criteria, maintain criteria groups, maintain evaluation templates, maintain job families, maintain positions, position import map, evaluation criteria uploads, and position uploads, Manage local settings: typically consisting of local information, local settings, maintain email reminders, and maintain notices. A navigation bar 165 displays “Compliance tools” the present interface screen. A title bar 167 displays “Compliance Tools Menu” with a listing of tools below. A my training plan 169 is a hot spot shown below bar 167. Selecting training plan 169 will display historical, present, and future training plans for individuals with staff when appropriate. A my transcript 171 is a hot spot shown below plan 169. Selecting transcript 171 will access transcripts for individuals with staff were appropriate for management and viewing.

FIG. 5 shows a manager tools page of a professional continuing competency optimizer. A manager tools interface screen 173 is shown. A right portion 175 of screen 173 features a simple list of immediately available destinations (each line is a hot spot for navigation to the respective interface screen). The lines displayed in portion 175 are title block (not a hot spot): CCO, Home (interface screen presently displayed), Logout (for exiting the system) and Help (assistance in navigation and entry of data), Compliance tools: typically consisting of individual training plans and transcripts, Manager tools: typically consisting of a dashboard with personal training plans, monitor competencies, evaluations, reports, and staff, Personal tools: typically consisting of personal information, email addresses, changing password, Document library: typically consisting of individual, local, organizational, and professional reference library documents, Reporting and analysis: typically consisting of competency reports, compliance records, department records, evaluation reports, reference lists, survey reports, and user reports, Manage openings: typically consisting of openings, users, bids, staff, calendar, and hospital, Manage competencies: typically consisting of maintain competencies, competency groups, competency uploads, and merge competencies, Manage documents and images: typically consisting of maintain documents, maintain document categories, and maintain images, Manage evaluations: typically consisting of maintain criteria, maintain criteria groups, maintain evaluation templates, maintain job families, maintain positions, position import map, evaluation criteria uploads, and position uploads, Manage local settings: typically consisting of local information, local settings, maintain email reminders, and maintain notices. A navigation bar 177 is shown displaying “Manager Tools”. A title bar 179 is shown displaying “Manager Tools Menu” with tools listed below. A my dashboard 181 hot spot is displayed below bar 179. Selecting dashboard 181 will facilitate viewing and managing of personal actions, deadlines, and activities to include; allocation activities, portfolio requirements, evaluation requirements, educational requirements, competency requirements, and training plans for individuals and staff were appropriate. Managers can reuse and share successful modules from efforts within other applications of their choosing. A monitor competencies 183 hot spot is displayed below dashboard 181. Selecting competencies 183 will facilitate viewing and managing of competencies, existing, current, and competencies that require assessment for individuals and staff where appropriate. A my evaluations 185 hot spot is displayed below competencies 183. Selecting evaluations 185 will facilitate viewing and managing of appropriate staff evaluations. A my reports 187 hot spot is displayed below evaluations 185. Selecting reports 187 will facilitate managing and viewing of an individual's saved reports. The types of reports that can be generated, viewed, and printed follow. (note: for each report type, there are several options provided for tailoring the report to specific needs, reports are modular and can be combined as required)
Compliance Reports assist in analyzing personal, departmental, and organizational compliance status.
Course Reports assist in analyzing course utilization and activity.
Credential Reports assist in tracking credentials and credential expirations in your organization.
Department Reports assist in analyzing departmental course utilization and users census.
Event Reports assist in managing events, instructors, attendees, and no-shows.
Reference Lists show application references such as departments, positions, and profiles.
Survey Reports show surveys and their results.
Test Reports show tests and their results.
User Reports track users, demographics, security, and transcripts.

A my staff 189 hot spot is displayed below reports 187. Selecting staff 189 will facilitate managing and viewing of information about an individual's staff.

FIG. 6 shows a personal tools page of a professional continuing competency optimizer. A personal tools interface screen is 191 shown. A right portion 193 of screen 191 features a simple list of immediately available destinations (each line is a hot spot for navigation to the respective interface screen). The lines displayed in portion 193 are title block (not a hot spot): CCO, Home (interface screen presently displayed), Logout (for exiting the system) and Help (assistance in navigation and entry of data), Compliance tools: typically consisting of individual training plans and transcripts, Manager tools: typically consisting of a dashboard with personal training plans, monitor competencies, evaluations, reports, and staff, Personal tools: typically consisting of personal information, email addresses, changing password, Document library: typically consisting of individual, local, organizational, and professional reference library documents, Reporting and analysis: typically consisting of competency reports, compliance records, department records, evaluation reports, reference lists, survey reports, and user reports, Manage openings: typically consisting of openings, users, bids, staff, calendar, and hospital, Manage competencies: typically consisting of maintain competencies, competency groups, competency uploads, and merge competencies, Manage documents and images: typically consisting of maintain documents, maintain document categories, and maintain images, Manage evaluations: typically consisting of maintain criteria, maintain criteria groups, maintain evaluation templates, maintain job families, maintain positions, position import map, evaluation criteria uploads, and position uploads, Manage local settings: typically consisting of local information, local settings, maintain email reminders, and maintain notices. A navigation bar 195 displays “Personal Tools” the present interface screen. A title bar 197 displays “Personal Tools Menu”. A my calendar 199 hot spot is shown below bar 197. Selecting calendar 199 facilitates managing, updating, and viewing of an individual's and staff calendar dates. A my personal information 201 hot spot is shown below calendar 199. Selecting information 201 will facilitate managing, updating, and viewing of an individual's and staff personal information. A my email address 203 is shown below information 201. Selecting address 203 facilitates an individual in changing of their email address. A change password 205 hot spot is shown below address 203. Selecting password 205 will facilitate an individual in requesting of changing their personal login password from the system provider.

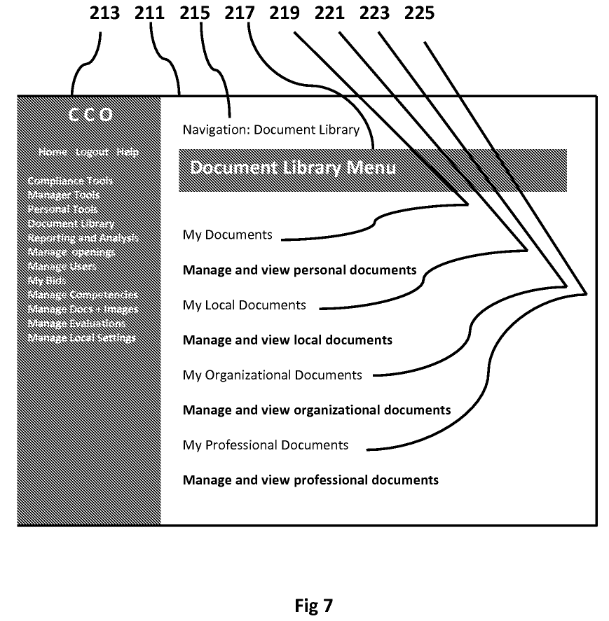

FIG. 7 shows a document library page of a professional continuing competency optimizer. A typical document library interface screen 211 is shown. A right portion 213 of screen 211 features a simple list of immediately available destinations (each line is a hot spot for navigation to the respective interface screen). The lines displayed in portion 213 are title block (not a hot spot): CCO, Home (interface screen presently displayed), Logout (for exiting the system) and Help (assistance in navigation and entry of data), Compliance tools: typically consisting of individual training plans and transcripts, Manager tools: typically consisting of a dashboard with personal training plans, monitor competencies, evaluations, reports, and staff, Personal tools: typically consisting of personal information, email addresses, changing password, Document library: typically consisting of individual, local, organizational, and professional reference library documents, Reporting and analysis: typically consisting of competency reports, compliance records, department records, evaluation reports, reference lists, survey reports, and user reports, Manage openings: typically consisting of openings, users, bids, staff, calendar, and hospital, Manage competencies: typically consisting of maintain competencies, competency groups, competency uploads, and merge competencies, Manage documents and images: typically consisting of maintain documents, maintain document categories, and maintain images, Manage evaluations: typically consisting of maintain criteria, maintain criteria groups, maintain evaluation templates, maintain job families, maintain positions, position import map, evaluation criteria uploads, and position uploads, Manage local settings: typically consisting of local information, local settings, maintain email reminders, and maintain notices. A navigation bar 215 displays “Document Library” the present interface screen. A title bar 217 displays “Document Library Menu” with Document categories listed below. A my documents 219 hot spot is shown below bar 217. Selecting documents 219 will facilitates an individual to manage and view personal documents. A my local documents 221 is shown below documents 219. Selecting documents 221 will facilitate managing and viewing local (regional) documents. A my organizational documents 223 is shown below documents 221. Selecting documents 223 will facilitate managing and viewing organizational documents. A my professional documents 225 is shown below documents 223. Selecting documents 225 will facilitate managing and viewing of an individual's and staff (where appropriate) professional documents such as portfolios. In this case a portfolio is a collection of individual's experience beyond a resume, which includes a representation of professional abilities, achievements, and efforts acts as a repository and safety-deposit box.

FIG. 8 shows a reporting and analysis page of a professional continuing competency optimizer. A typical reporting and analysis interface screen 231 is shown. A right portion 233 of screen 231 features a simple list of immediately available destinations (each line is a hot spot for navigation to the respective interface screen). The lines displayed in portion 233 are title block (not a hot spot): CCO, Home (interface screen presently displayed), Logout (for exiting the system) and Help (assistance in navigation and entry of data), Compliance tools: typically consisting of individual training plans and transcripts, Manager tools: typically consisting of a dashboard with personal training plans, monitor competencies, evaluations, reports, and staff, Personal tools: typically consisting of personal information, email addresses, changing password, Document library: typically consisting of individual, local, organizational, and professional reference library documents, Reporting and analysis: typically consisting of competency reports, compliance records, department records, evaluation reports, reference lists, survey reports, and user reports, Manage openings: typically consisting of openings, users, bids, staff, calendar, and hospital, Manage competencies: typically consisting of maintain competencies, competency groups, competency uploads, and merge competencies, Manage documents and images: typically consisting of maintain documents, maintain document categories, and maintain images, Manage evaluations: typically consisting of maintain criteria, maintain criteria groups, maintain evaluation templates, maintain job families, maintain positions, position import map, evaluation criteria uploads, and position uploads, Manage local settings: typically consisting of local information, local settings, maintain email reminders, and maintain notices. A navigation bar 235 displays “Reports” the present interface screen. A title bar 237 displays “Reporting and Analysis Menu” with selection listed below. A competency reports 239 hot spot is shown below bar 237. Selecting reports 239 facilitates managing and viewing of reports about competencies (checklists) and their results. A compliance reports 241 hot spot is shown below reports 239. Selecting reports 241 facilitates managing and viewing reports about personal, departmental, and organizational compliance. A department reports 243 hot spot is shown below reports 241. Selecting reports 243 facilitates managing and viewing reports about departmental course utilization. An evaluations reports 245 hot spot is shown below reports 243. Selecting reports 245 facilitates managing and viewing reports about evaluations. A reference lists 247 is shown below reports 245. Selecting lists 247 facilitates managing and viewing reports and lists of application references. A survey reports 249 is shown below lists 247. Selecting reports 249 facilitates managing and viewing reports about survey and their results. A user reports 250 is shown below reports 249. Selecting reports 250 facilitates managing and viewing reports about users, demographics, security, and transcripts. All reports are modular and transportable resources to be mixed and matched as required by individuals to generate comprehensive reports with a minimum of effort.

FIG. 9 shows a manage openings page of a professional continuing competency optimizer. A typical manage openings interface screen 251 is shown. A right portion 253 of screen 251 features a simple list of immediately available destinations (each line is a hot spot for navigation to the respective interface screen). The lines displayed in portion 253 are title block (not a hot spot): CCO, Home (interface screen presently displayed), Logout (for exiting the system) and Help (assistance in navigation and entry of data), Compliance tools: typically consisting of individual training plans and transcripts, Manager tools: typically consisting of a dashboard with personal training plans, monitor competencies, evaluations, reports, and staff, Personal tools: typically consisting of personal information, email addresses, changing password, Document library: typically consisting of individual, local, organizational, and professional reference library documents, Reporting and analysis: typically consisting of competency reports, compliance records, department records, evaluation reports, reference lists, survey reports, and user reports, Manage openings: typically consisting of openings, users, bids, staff, calendar, and hospital, Manage competencies: typically consisting of maintain competencies, competency groups, competency uploads, and merge competencies, Manage documents and images: typically consisting of maintain documents, maintain document categories, and maintain images, Manage evaluations: typically consisting of maintain criteria, maintain criteria groups, maintain evaluation templates, maintain job families, maintain positions, position import map, evaluation criteria uploads, and position uploads, Manage local settings: typically consisting of local information, local settings, maintain email reminders, and maintain notices. A navigation bar 255 displays “Manage openings” the present interface screen. A title bar 257 displays “Manage Openings” with managing tools listed below. A my openings 259 hot spot is shown below bar 257. Selecting openings 259 facilitates managing and viewing of available and previous openings. A my staff 261 hot spot is shown below openings 259. Selecting staff 261 facilitates managing and viewing of available staff capabilities and history. A my users 263 hot spot is shown below staff 261. Selecting users 263 facilitates managing and viewing of available users. User information allows managers and individuals (as appropriate) to maintain important user information such as credentials, profiles, departments, etc. This information is used throughout the system to determine required courses, track compliance, update the database, and other important functions. The following tasks are included in this section:
Maintain Users
Merge Users
Maintain Credentials
Maintain Profiles
Maintain Departments
Maintain Positions
Maintain Shifts
Assign Profiles

A my bids 265 hot spot is shown below users 263. Selecting bids 265 facilitates managing and viewing active and past bids. A my hospital 267 hot spot is shown below bids 265. Selecting hospital 267 facilitates managing and viewing of present organization's staffing profiles.

FIG. 10 shows a manage competencies page of a professional continuing competency optimizer. A typical manage competencies interface screen 271 is shown. A right portion 273 of screen 271 features a simple list of immediately available destinations (each line is a hot spot for navigation to the respective interface screen). The lines displayed in portion 273 are title block (not a hot spot): CCO, Home (interface screen presently displayed), Logout (for exiting the system) and Help (assistance in navigation and entry of data), Compliance tools: typically consisting of individual training plans and transcripts, Manager tools: typically consisting of a dashboard with personal training plans, monitor competencies, evaluations, reports, and staff, Personal tools: typically consisting of personal information, email addresses, changing password, Document library: typically consisting of individual, local, organizational, and professional reference library documents, Reporting and analysis: typically consisting of competency reports, compliance records, department records, evaluation reports, reference lists, survey reports, and user reports, Manage openings: typically consisting of openings, users, bids, staff, calendar, and hospital, Manage competencies: typically consisting of maintain competencies, competency groups, competency uploads, and merge competencies, Manage documents and images: typically consisting of maintain documents, maintain document categories, and maintain images, Manage evaluations: typically consisting of maintain criteria, maintain criteria groups, maintain evaluation templates, maintain job families, maintain positions, position import map, evaluation criteria uploads, and position uploads, Manage local settings: typically consisting of local information, local settings, maintain email reminders, and maintain notices. A navigation bar 275 displays “Manage Competencies” the present interface screen. A title bar 277 displays “Manage Competencies Menu” with managing tools listed below. A maintain competencies 279 hot spot is shown below bar 277. Selecting competencies 279 facilitates managing, adding, updating, removing, and viewing competency checklists. A maintain competency groups 281 hot spot is shown below competencies 279. Selecting groups 281 facilitates managing, adding, viewing, and deleting evaluation competency groups. A competency uploads 283 hot spot is shown below groups 281. Selecting uploads 283 facilitates uploading and importing of competency checklists and items. A merge competencies 285 hot spot is shown below uploads 283. Selecting competencies 285 facilitates merging selected competency transcript information from one course to another course and updating the profile references.

FIG. 11 shows a manage documents and images page of a professional continuing competency optimizer. A typical manage documents and images interface screen 291 is shown. A right portion 293 of screen 291 features a simple list of immediately available destinations (each line is a hot spot for navigation to the respective interface screen). The lines displayed in portion 293 are title block (not a hot spot): CCO, Home (interface screen presently displayed), Logout (for exiting the system) and Help (assistance in navigation and entry of data), Compliance tools: typically consisting of individual training plans and transcripts, Manager tools: typically consisting of a dashboard with personal training plans, monitor competencies, evaluations, reports, and staff, Personal tools: typically consisting of personal information, email addresses, changing password, Document library: typically consisting of individual, local, organizational, and professional reference library documents, Reporting and analysis: typically consisting of competency reports, compliance records, department records, evaluation reports, reference lists, survey reports, and user reports, Manage openings: typically consisting of openings, users, bids, staff, calendar, and hospital, Manage competencies: typically consisting of maintain competencies, competency groups, competency uploads, and merge competencies, Manage documents and images: typically consisting of maintain documents, maintain document categories, and maintain images, Manage evaluations: typically consisting of maintain criteria, maintain criteria groups, maintain evaluation templates, maintain job families, maintain positions, position import map, evaluation criteria uploads, and position uploads, Manage local settings: typically consisting of local information, local settings, maintain email reminders, and maintain notices. A navigation bar 295 displays “Mange Documents and Images” the present interface screen. A navigation bar 295 displays “Manage Documents and Images” the present screen interface. A title bar 297 displays “Manage Documents and Images Menu” with document and image tools listed below. A maintain documents 299 hot spot is shown below bar 297. Selecting documents 299 will facilitate managing, adding, viewing, and deleting online documents. A maintain document categories 301 hot spot is shown below documents 299. Selecting categories 301 will facilitate managing, adding, viewing, and deleting document categories. A maintain images 303 hot spot is shown below categories 301. Selecting images 303 will facilitate managing, adding, viewing, updating, and deleting online images.

FIG. 12 shows a manage evaluations page of a professional continuing competency optimizer. A typical manage evaluations interface screen 311 is shown. The evaluation interface screen 311 provides the manager with the tools to simplify creation, conducting, and managing evaluations. The robust availability of tools and sharing of information and data reduce the time a manage spends on evaluations while producing an more timely and accurate evaluation. A right portion 313 of screen 311 features a simple list of immediately available destinations (each line is a hot spot for navigation to the respective interface screen). The lines displayed in portion 313 are title block (not a hot spot): CCO, Home (interface screen presently displayed), Logout (for exiting the system) and Help (assistance in navigation and entry of data), Compliance tools: typically consisting of individual training plans and transcripts, Manager tools: typically consisting of a dashboard with personal training plans, monitor competencies, evaluations, reports, and staff, Personal tools: typically consisting of personal information, email addresses, changing password, Document library: typically consisting of individual, local, organizational, and professional reference library documents, Reporting and analysis: typically consisting of competency reports, compliance records, department records, evaluation reports, reference lists, survey reports, and user reports, Manage openings: typically consisting of openings, users, bids, staff, calendar, and hospital, Manage competencies: typically consisting of maintain competencies, competency groups, competency uploads, and merge competencies, Manage documents and images: typically consisting of maintain documents, maintain document categories, and maintain images, Manage evaluations: typically consisting of maintain criteria, maintain criteria groups, maintain evaluation templates, maintain job families, maintain positions, position import map, evaluation criteria uploads, and position uploads, Manage local settings: typically consisting of local information, local settings, maintain email reminders, and maintain notices. A navigation bar 315 displays “Manage Evaluations” the present interface screen. A title bar 317 displays “Manage Evaluations Menu” with evaluation tools listed below. A maintain criteria 319 hot spot is shown below bar 317. Selecting criteria 319 will facilitate managing, adding, viewing, updating, and deleting evaluation criteria. A maintain criteria groups 321 hot spot is shown below criteria 319. Selecting groups 321 will facilitate managing, adding, viewing, updating, and deleting evaluation criteria groups. A maintain evaluation templates 323 hot spot is shown below groups 321. Selecting templates 323 will facilitate managing, adding, viewing, updating, and deleting performance evaluation templates. A maintain job families 325 hot spot is shown below templates 323. Selecting families 325 will facilitate managing, adding, viewing, updating, and deleting job families. A maintain positions 327 hot spot is shown below families 325. Selecting positions 327 will facilitate managing, adding, viewing, updating, and deleting positions. A position import mapping 329 hot spot is shown below positions 327. Selecting mapping 329 will facilitate managing, adding, viewing, updating, and deleting position mapping used during automatic import of user demographics. An evaluation criteria uploads 331 is shown below mapping 329. Selecting uploads 331 will facilitate editing of upload and import evaluation criteria and items. A position updates 333 is shown below uploads 331. Selecting updates 333 will facilitate editing of upload and import positions and job requirements.

FIG. 13 shows a manage local settings page of a professional continuing competency optimizer. A typical manage local settings interface screen 351 is shown. A right portion 353 of screen 351 features a simple list of immediately available destinations (each line is a hot spot for navigation to the respective interface screen). The lines displayed in portion 353 are title block (not a hot spot): CCO, Home (interface screen presently displayed), Logout (for exiting the system) and Help (assistance in navigation and entry of data), Compliance tools: typically consisting of individual training plans and transcripts, Manager tools: typically consisting of a dashboard with personal training plans, monitor competencies, evaluations, reports, and staff, Personal tools: typically consisting of personal information, email addresses, changing password, Document library: typically consisting of individual, local, organizational, and professional reference library documents, Reporting and analysis: typically consisting of competency reports, compliance records, department records, evaluation reports, reference lists, survey reports, and user reports, Manage openings: typically consisting of openings, users, bids, staff, calendar, and hospital, Manage competencies: typically consisting of maintain competencies, competency groups, competency uploads, and merge competencies, Manage documents and images: typically consisting of maintain documents, maintain document categories, and maintain images, Manage evaluations: typically consisting of maintain criteria, maintain criteria groups, maintain evaluation templates, maintain job families, maintain positions, position import map, evaluation criteria uploads, and position uploads, Manage local settings: typically consisting of local information, local settings, maintain email reminders, and maintain notices. A navigation bar 355 displays “Manage Local Settings” the present interface screen. A title bar 357 displays “Manage Local Settings Menu” with settings tools listed below. A local information 359 hot spot is shown below bar 357. Selecting information 359 will facilitate managing and viewing your organization name, address, and contact info. A local setting 361 hot spot is shown below information 359. Selecting setting 361 will facilitate maintaining local settings such as the selected login survey. A maintain email reminders 363 hot spot is shown below setting 361. Selecting reminders 363 will facilitate managing, viewing, and updating the settings for unified (all organizational functional modules) email reminders. A maintain notices 365 hot spot is shown below reminders 363. Selecting notices 365 will facilitate managing, adding, viewing, updating, and deleting login announcements and flash messages. A my web links 367 hot spot is shown below notices 365. Selecting links 367 will facilitate managing, viewing, and creating web links. A my wizards 369 hot spot is shown below links 367. Selecting wizards 369 will facilitate managing, viewing, and importing your wizards.

A suitable discussion of individual programs is disclosed in more detail in “System and method for organizational and personal portfolios” by Kenneth W. Dion application Ser. No. 11/542,839, dtd. Oct. 4, 2006, “System and method for implementing critical checklists” by Kenneth W. Dion application Ser. No. 11/712,114, dtd. Feb. 28, 2007, “Method and system for educational compliance and competency management” by Kenneth W. Dion application Ser. No. 11/821,405, dtd. Jun. 22, 2007, “System and method for dynamic staff bidding” by Kenneth W. Dion application Ser. No. 11/888,159, dtd. Jul. 31, 2007. “System, method, and computer product for implementing a 360 degree critical evaluator” by Kenneth W. Dion, application Ser. No. 12/214,185, dtd. Jun. 16, 2008. The subject matter of which is hereby incorporated by reference in it's entirety into this disclosure

### Operation

An organization operates a professional continuing competency optimizer by first contacting the service provider and establishing an agreement to remotely implement a local service network with the installed software. The configuration will typically be as shown in FIG. 1 with the initial setup, flow, and operation as described in FIG. 2. The security of the system is enhanced by provider issuing and monitoring of passwords and traffic monitoring. Individuals and management will typically navigate through the interface screens as shown in FIGS. 2 through 13. The enhanced secure database and data element structure sharing with modular reports, records, evaluations, checklists, and staffing tools will allow minimal entry and retrieval efforts by individuals and management to achieve accelerated professional and organizational growth.

### DESCRIPTION OF THE PREFERRED EMBODIMENT(S)

A preferred embodiment of a professional continuing competency optimizer is architected as shown in FIG. 1 wherein an integrated, network available, software package is available to a contracting organizations from a provider over an internet to fulfill all the personal support needs of the organization in obtaining, qualifying, nurturing, and reinforcing positive behavior through accurate and timely reviews. The built-in data compatibility and data sharing of the optimizer minimizes the data entry and follow up necessary for a manager and an individual. The structured rules built into the optimizer assure compliance with the organization and certifying agencies also increasing the positive experience for both the managers and individuals. The full range of reports and options (FIGS. 5 and 8) to adapt reports further simplifies the managers tasks for achieving compliance while still performing professional tasks with a minimum of repetitive tasks. The software of this preferred embodiment will flow as described in FIG. 2. Individual aspects of the operation and features of the optimizer are described in FIGS. 3 through 13.

What is claimed is:

1. A synergistic system for supporting an organizations optimization of continuing competency for professionals including a functional means for staff allocation, individual portfolios, performance management, educational management, and individual competency management through a collection of seamless internet supplied computer interface screens with an uniform underlying data record format and inter-accessible programs contained in an integrated data base for all personnel functions within an organization the system consisting of:
A means for providing interactively at least one client of an organization access to a provider's computer, database, and operational software over such as an internet,
A means for implementing access security through the provider issued and maintained passwords for individual clients,
A means for the client to install operational software, obtain access, and utilize interface screens over such as the internet on a client organization's computer and computer network,
A means of implementing the collection of computer interface screens with underlying data compatibility for entering individual data for staff allocation, individual portfolios, performance management, educational management, and individual competency management that simplifies the workloads placed on individuals within the organization,
A means of implementing the collection of computer interface screens with underlying data compatibility for managing, tracking, and updating staff allocation, individual portfolios, performance management, educational management, and individual competency management that eases the workloads placed on individuals within the organization,
A means for generating qualitative and quantitative reports with modularity that through simple interface actions that contribute to individual information retention, through reduced effort encouraging professional growth,
A means for presenting current status through an individual dashboard containing highlights of an individual's actions, deadlines, and organizational activities,
A means for keeping individual and client organizational certification current through competency monitoring,
A unified means to provide staged reminders to responsible individuals for actions required involving all personnel aspects of a client organization, and
An evaluation system for encouraging and rewarding positive; and
enhancing an organization's overall efficiency and performance through reduced support time requirements to assure a talented reliable staffing solution that improves with experience.

2. The synergistic system for supporting an organizations optimization of continuing competency for professionals according to claim 1 wherein allocating of shift positions is facilitated through simple computer interface screens with online availability of pre-qualified staff.

3. The synergistic system for supporting an organizations optimization of continuing competency for professionals according to claim 1 wherein creation, management and updating of individual portfolios is facilitated through simple computer interface screens, shared databases, modular information, and internet availability.

4. The synergistic system for supporting an organizations optimization of continuing competency for professionals according to claim 1 wherein system accessible interfaces improve accuracy and quality of individual evaluations encouraging individual professional development.

5. The synergistic system for supporting an organizations optimization of continuing competency for professionals according to claim 1 wherein delivery and tracking of an educational portion of competency is facilitated through a series of simple computer interfaces, tests, reuse, and common databases.

6. The synergistic system for supporting an organizations optimization of continuing competency for professionals according to claim 1 wherein a collection of competency checklists are available to assess individual competencies before critical tasks are performed.

7. The synergistic system for supporting an organizations optimization of continuing competency for professionals according to claim 1 wherein the entire support system utilizes a compatible data word format facilitating data information sharing.

8. The synergistic system for supporting an organizations optimization of continuing competency for professionals according to claim 1 wherein an organization's support operations are streamlined through a computer architecture that facilitates inter-accessible information, reducing information and data entry effort by individuals.

9. The synergistic system for supporting an organizations optimization of continuing competency for professionals according to claim 1 wherein support operations are improved through a computer architecture that facilitates a system wide integrated database, reducing system support coordination efforts.

10. The synergistic system for supporting an organizations optimization of continuing competency for professionals according to claim 1 wherein the organization's entering of data are simplified through an inter-accessible computer architecture with a compatible data word format.

11. The synergistic system for supporting an organizations optimization of continuing competency for professionals according to claim 1 wherein managing, tracking, and updating of an individual's professional information are streamlined through a computer architecture implementing a shared database and compatible data word format.

12. The synergistic system for supporting an organizations optimization of continuing competency for professionals according to claim 1 wherein computer architecture with a shared database, compatible data word format, and modular information resources reduce the efforts for an individual to produce unified organization reports.

13. The synergistic system for supporting an organizations optimization of continuing competency for professionals according to claim 1 wherein computer architecture with a shared database, inter-accessible programs, compatible data word format, and modular information resources facilitate a tracking of individual status including current and future professional activities.

14. A method of providing optimization of continuing competency for professionals within an organization which comprises:
Connecting at least one client in an organization over a network to a service provider,
Connecting to multiple individuals within an organization's network to a service provider,
Facilitating secure individual data entry into organizational databases,
Facilitating secure storage of individual's data by organization,
Facilitating secure access to an individual's data through a collection of computer interface screens within an organizations network,
Allocating staff for satisfying shift position needs through an internet available list of prequalified bidders,
Facilitating secure interactive access to individual portfolios through a collection of computer interface screens within an organizations' network,
Facilitating streamlining of an organizations' performance management with focus on quality and improvement through accurate assessment of performance and competencies with minimized effort,
Facilitating simplifying of educational management utilizing organizational standard shared information modules for reuse, delivery and tracking,
Facilitating individual competency management through a collection of organizational checklists that evaluate competency before a task is performed,
Implementing a collection of seamless interface screens through a sharing of compatible data word format, integrated database storage, and secure access,
Facilitating an organization's growth through system organization data availability and modular reporting functionality.
Facilitating viewing and managing of personal actions, deadlines, and activities through an individual's dashboard,
Facilitating obtaining and maintaining an organization's certification through a procedure of policies, procedures, and record keeping that minimize staff efforts,
Facilitating timely satisfaction of all of an individual's timed requirements through a procedure of unified reminders, and
Facilitating a reduced effort evaluation method incorporating a management procedure that reduces manager's time necessary for performing evaluations.

15. The method of providing optimization of continuing competency for professionals within an organization of claim 14 wherein; staffing of shift positions is accomplished through an internet available list of pre-qualified staff.

16. The method of providing optimization of continuing competency for professionals within an organization of claim 14 wherein; creating, maintaining, and managing individual portfolios is accomplished through simple computer interface methods, shared databases, and internet availability

17. The method of providing optimization of continuing competency for professionals within an organization of claim 14 wherein; creating, conducting, and managing individual evaluations is accomplished through interface methods that improve accuracy and quality of individual evaluations encouraging individual professional development.

18. The method of providing optimization of continuing competency for professionals within an organization of claim 14 wherein; delivering and tracking of an educational portion of competency is facilitated through a procedure of simple computer interfaces, organizational training modules, and common database methods.

19. The method of providing optimization of continuing competency for professionals within an organization of claim 14 wherein; creating, testing, and managing an educational portion of competency is facilitated through a procedure of simple computer methods, checklists, and common database methods.

20. The method of providing optimization of continuing competency for professionals within an organization of claim 14 wherein; sharing of organization's information and data are simplified through a computer procedure utilizing a compatible data word method.

21. The method of providing optimization of continuing competency for professionals within an organization of claim 14 wherein; managing all aspects of personal management is facilitated through a method of inter-accessible program methods.

22. The method of providing optimization of continuing competency for professionals within an organization of claim 14 wherein; securely interchanging an organization's information and data to reduce operator effort are facilitated through a method implementing an integrated data base.

23. The method of providing optimization of continuing competency for professionals within an organization of claim 14 wherein; Managing, tracking, and updating of an individual's data are simplified through a method implementing an integrated data base.

24. The method of providing optimization of continuing competency for professionals within an organization of claim 14 wherein; generating an organization's unified reports is simplified through a method of available modular reports.

25. A computer product of a synergistic system for supporting an organizations optimization of continuing competency for professionals including functional means for staff allocation, individual portfolios, performance management, educational management, and individual competency management producing a collection of seamless internet supplied computer interface screens through an uniform underlying data record format and inter-accessible programs contained in an integrated data base with modular availability for all personnel functions within an organization.
